(19) United States
(12) Patent Application Publication
(10) Pub. No.: US 2026/0356222 A1
(43) Pub. Date: Nov. 12, 2026

(54) CHARGING AND DISCHARGING A BATTERY ASSEMBLY USING A DUAL INVERTER MOTOR SYSTEM

(71) Applicant: GM GLOBAL TECHNOLOGY OPERATIONS LLC, DETROIT, MI (US)

(72) Inventors: Yilun Luo, Ann Arbor, MI (US); Minh-Khai Nguyen, Troy, MI (US); Lei Hao, Shelby Township, MI (US); Brian A. Welchko, Oakland Townhip, MI (US)

(21) Appl. No.: 19/200,882

(22) Filed: May 7, 2025

(51) Int. Cl. B60L 53/24; B60L 53/16; B60L 55/00; H02M 1/42; H02M 3/335; H02M 7/797

(52) U.S. Cl. CPC B60L 53/24; B60L 53/16; B60L 55/00; H02M 1/4233; H02M 3/33573; H02M 3/33592; H02M 7/797; B60L 2210/10; B60L 2210/30; B60L 2210/40

(57) ABSTRACT

A system for controlling charging and discharging includes an electrical system including a power module selectively connected to a battery assembly, the power module including a direct current (DC)-DC conversion device, the battery assembly configured to provide power to a dual inverter motor system including a first inverter and a second inverter connected to a multi-phase electric motor by a propulsion bus, the first inverter including a first plurality of phase legs and the second inverter including a second plurality of phase legs. The system also includes a charge port circuit including a charge port conductor configured to selectively connect a set of windings of the multi-phase electric motor to a charge port, a switching assembly including a charge port switch at the charge port conductor, and a controller configured to transition the electrical system between a propulsion mode and a charging mode by controlling the charge port switch.

### INTRODUCTION

The disclosure relates to vehicles having electric motors. More specifically, the disclosure relates to electric vehicle charging and discharging.

Vehicles, including gasoline and diesel power vehicles, as well as electric and hybrid electric vehicles, feature battery storage for purposes such as powering electric motors, electronics and other vehicle subsystems. Such vehicles typically include modules for controlling aspects of charging battery systems. In addition, vehicles may have discharging capabilities for supplying power to external loads (vehicle-to-load or V2L charging), such as power tools, power grids and residential electrical systems, and/or other vehicles (vehicle-to-vehicle or V2V charging). It is desirable to provide systems and methods that improve efficiency and performance of charging and discharging.

### SUMMARY

In one exemplary embodiment, a system for controlling charging and discharging includes an electrical system including a power module selectively connected to a battery assembly, the power module including a direct current (DC)-DC conversion device, the battery assembly configured to provide power to a dual inverter motor system, the dual inverter motor system including a first inverter and a second inverter connected to a multi-phase electric motor by a propulsion bus, the first inverter including a first plurality of phase legs and the second inverter including a second plurality of phase legs. The system also includes a charge port circuit including a charge port conductor configured to selectively connect a set of windings of the multi-phase electric motor to a charge port, a switching assembly including a charge port switch at the charge port conductor, and a controller configured to transition the electrical system between a propulsion mode and a charging mode by controlling the charge port switch. The controller is configured to control the electrical system in the charging mode to charge the battery assembly or supply power to a load through the dual inverter motor system.

In addition to the one or more features described herein, the charge port circuit is configured to cause power flow through at least one winding of the multi-phase electric motor for power factor correction and bi-directional alternating current (AC)-DC conversion.

In addition to the one or more features described herein, the charge port circuit includes a first conductor connecting the charge port to one of the set of windings through a phase leg of one of the first inverter or the second inverter, and a second conductor connecting the charge port to another of the set of windings through a phase leg of another of the first inverter or the second inverter.

In addition to the one or more features described herein, the controller is configured to select the at least one winding for the power factor correction and the bi-directional AC-DC conversion by controlling at least one switch in the first inverter.

In addition to the one or more features described herein, the controller is configured to select the at least one winding based on a rotor position of the multi-phase electric motor.

In addition to the one or more features described herein, the controller is configured to select multiple windings and perform interleaved power factor correction by controlling at least one switch that is connected to a selected winding.

In addition to the one or more features described herein, the charge port circuit includes a plurality of conductors connecting the charge port to each winding of the set of windings and to each phase leg of the first inverter or the second inverter, and the charge port circuit includes an additional conductor connecting the charge port to a neutral point of the electrical system or a midpoint between a pair of switches connected in parallel with the first inverter and the second inverter.

In addition to the one or more features described herein, each of the plurality of conductors includes a respective charge port switch, and the controller is configured to control one or more of the respective charge port switches to select multi-phase or single-phase charging or discharging.

In another exemplary embodiment, a method includes monitoring an electrical system including a power module selectively connected to a battery assembly, the power module including a direct current (DC)-DC conversion device, the battery assembly configured to provide power to a dual inverter motor system, the dual inverter motor system including a first inverter and a second inverter connected to a multi-phase electric motor by a propulsion bus, the first inverter including a first plurality of phase legs and the second inverter including a second plurality of phase legs. The method also includes causing the electrical system to transition between a propulsion mode and a charging mode by controlling a charge port circuit, the charge port circuit including a charge port conductor that selectively connects a set of windings of the multi-phase electric motor to a charge port, where the controlling includes opening or closing a charge port switch at the charge port conductor, and based on the electrical system being in the charging mode, controlling the electrical system in the charging mode to charge the battery assembly or supply power to a load through the dual inverter motor system.

In addition to the one or more features described herein, the charge port circuit is configured to cause power flow through at least one winding of the multi-phase electric motor for power factor correction and bi-directional alternating current (AC)-DC conversion.

In addition to the one or more features described herein, the charge port circuit includes a first conductor connecting the charge port to one of the set of windings through a phase leg of one of the first inverter or the second inverter, and a second conductor connecting the charge port to another of the set of windings through a phase leg of another of the first inverter or the second inverter.

In addition to the one or more features described herein, controlling the electrical system includes selecting the at least one winding for the power factor correction and the bi-directional AC-DC conversion by controlling at least one switch in the first inverter.

In addition to the one or more features described herein, the at least one winding is selected based on a rotor position of the multi-phase electric motor.

In addition to the one or more features described herein, controlling the electrical system includes selecting multiple windings and performing interleaved power factor correction by controlling at least one switch that is connected to a selected winding.

In addition to the one or more features described herein, the charge port circuit includes a plurality of conductors connecting the charge port to each winding of the set of windings and to each phase leg of the first inverter or the second inverter, and the charge port circuit includes an additional conductor connecting the charge port to a neutral point of the electrical system or a midpoint between a pair of switches connected in parallel with the first inverter and the second inverter.

In addition to the one or more features described herein, each of the plurality of conductors includes a respective charge port switch, and the method further comprises controlling one or more of the respective charge port switches to select multi-phase or single-phase charging or discharging.

In yet another exemplary embodiment, a vehicle system includes a dual inverter motor system including a first inverter and a second inverter connected to a multi-phase electric motor, the first inverter including a first plurality of phase legs and the second inverter including a second plurality of phase legs. The vehicle system also includes a power module selectively connected to a battery assembly, the power module including a direct current (DC)-DC conversion device, the battery assembly configured to provide power to the dual inverter motor system. The vehicle system further includes a charge port circuit including a charge port conductor configured to selectively connect a set of windings of the multi-phase electric motor to a charge port, a switching assembly including a charge port switch at the charge port conductor, and a controller configured to transition the vehicle system between a propulsion mode and a charging mode by controlling the charge port switch, wherein the controller is configured to control the vehicle system in the charging mode to charge the battery system or supply power to a load through the dual inverter motor system.

In addition to the one or more features described herein, the charge port circuit is configured to cause power flow through at least one winding of the multi-phase electric motor for power factor correction and bi-directional alternating current (AC)-DC conversion.

In addition to the one or more features described herein, the charge port circuit includes a first conductor connecting the charge port to one of the set of windings through a phase leg of one of the first inverter or the second inverter, and a second conductor connecting the charge port to another of the set of windings through a phase leg of another of the first inverter or the second inverter.

In addition to the one or more features described herein, the controller is configured to select the at least one winding for the power factor correction and the bi-directional AC-DC conversion by controlling at least one switch in the first inverter.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a schematic diagram of an electric or hybrid vehicle, in accordance with an exemplary embodiment;

FIG. 2 is a circuit diagram illustrating a power module configured to control aspects of single-phase charging and discharging using an open winding or dual inverter motor system, in accordance with an exemplary embodiment;

FIG. 3 is a circuit diagram illustrating a power module configured to control aspects of multi-phase charging and discharging using an open winding or dual inverter motor system, in accordance with an exemplary embodiment;

FIG. 4 is a circuit diagram illustrating a power module configured to control aspects of multi-phase charging and discharging using an open winding or dual inverter motor system, in accordance with an exemplary embodiment;

FIG. 5 is a circuit diagram illustrating a power module configured to control aspects of charging and discharging using an open winding or dual inverter motor system, the power module being configurable for single-phase or multi-phase charging and discharging, in accordance with an exemplary embodiment;

FIGS. 6A and 6B illustrate examples of configurations for selectively connecting a battery system to a power module and an open winding or dual inverter motor system, in accordance with an exemplary embodiment; and

FIG. 7 depicts a computer system for performing aspects of charging and discharging, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments, methods, devices and systems are provided for facilitating charging and discharging of battery assemblies and battery systems, such as vehicle battery assemblies. An embodiment of an electrical system of a vehicle includes a power module having a conversion device or devices (e.g., a direct current (DC)-DC converter). The power module is connected to a dual inverter motor system, which may be part of an electric or hybrid vehicle. The power module may be used for single-phase or multi-phase charging for various charging and discharging operations (e.g., vehicle battery charging, vehicle-to-load charging, etc.).

The controller may operate the charging module to control aspects of power conversion. In an embodiment, during a charging or discharging operation, an open winding of the motor is utilized for power factor correction (PFC) and bi-directional alternating current (AC)-DC conversion (e.g., bi-directional AC-DC conversion).

Embodiments described herein present a number of advantages. The embodiments provide for improved charging and discharging in systems that utilize open winding machines. Control of power transfer is thus achievable without the need for large capacitors or other resource-intensive components, by re-using existing components of a vehicle or other system.

Conventional charging modules have subsystems for various purposes, which include AC-DC rectifiers, power factor correction (PFC) converters (e.g., boost converters), DC-DC converters and filters. Embodiments described herein utilize a motor inverter for rectification, and an open winding of a motor for a PFC stage. In this way, the size of a power module, as well as the amount of resources needed to construct a power module, are greatly reduced. For example, embodiments allow for charging modules or power modules that do not require dedicated rectifiers or large DC-link capacitors that are typically used for PFC.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

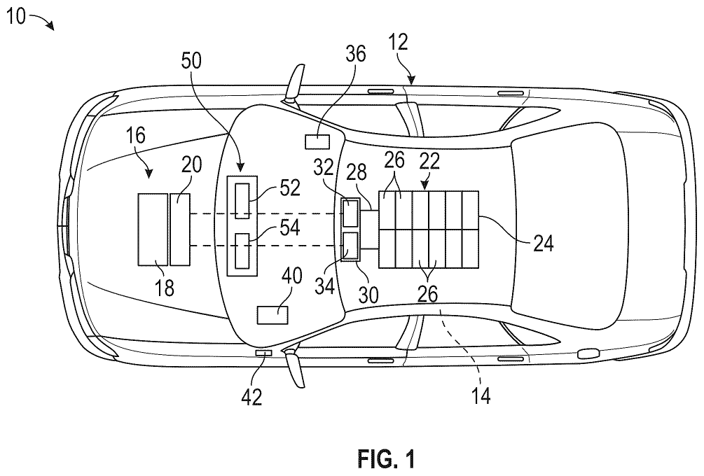

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations. The vehicle 10 may be a fully electric vehicle having one or more electric motors.

The vehicle 10 includes a battery system 22, which may be electrically connected to the motor 20 and/or other components, such as vehicle electronics. The battery system 22 may be configured as a rechargeable energy storage system (RESS). In an embodiment, the battery system 22 includes a battery assembly such as a high voltage battery pack 24 having a plurality of battery modules 26.

The battery system 22 is electrically connected to components of the propulsion system 16. The propulsion system 16 includes a DC-DC converter 28, and an inverter system 30 (e.g., includes one or more traction power inverter units or TPIMs) configured to convert DC power from the battery system 22 to poly-phase alternating current AC power (e.g., three-phase, six-phase, etc.) to drive the motor 20.

In an embodiment, the electric motor 20 is an open winding motor, which is driven by a dual inverter system. The inverter system 30, in this embodiment, is a dual inverter system that includes two inverters 32 and 34. The inverters 32 and 34 may be two-level or multilevel (i.e., three-level or higher). Each winding of the motor 20 is connected to a phase leg of both inverters 32 and 34, as discussed further herein. Although two inverters are discussed, embodiments are not so limited, as an additional inverter or inverters may be included if the motor 20 has additional windings.

Various control modules (electronic control modules or ECUs) may be included in the vehicle 10. For example, a vehicle controller 36 is configured to control operation of the motor 20 and the inverter system 30. The vehicle controller 36 drives the motor by applying a pulse width modulation (PWM) scheme to control switches in the dual inverter system. The controller 36 may control the motor 20 according to an open winding mode or a closed winding mode as described herein.

Other examples of control modules include a power module 40 that is configured to control aspects of charging the battery pack 24, and discharging the battery pack 24 to supply power to an external system, such as a power grid or other vehicle. The power module 40 is selectively connected to charge port 42. The charge port 42 may be a bidirectional charge port for charging the battery system 22 or discharging the battery system 22 to supply power to an external load.

The vehicle 10 also includes a computer system 50 that includes one or more processing devices 52 and a user interface 54. The various processing devices and units may communicate with one another via a communication device or system, such as a controller area network (CAN) or transmission control protocol (TCP) bus.

Although embodiments are described using the vehicle controller 36 to perform functions described herein, embodiments are not so limited. Any suitable processor or processing system may be used for various control functions.

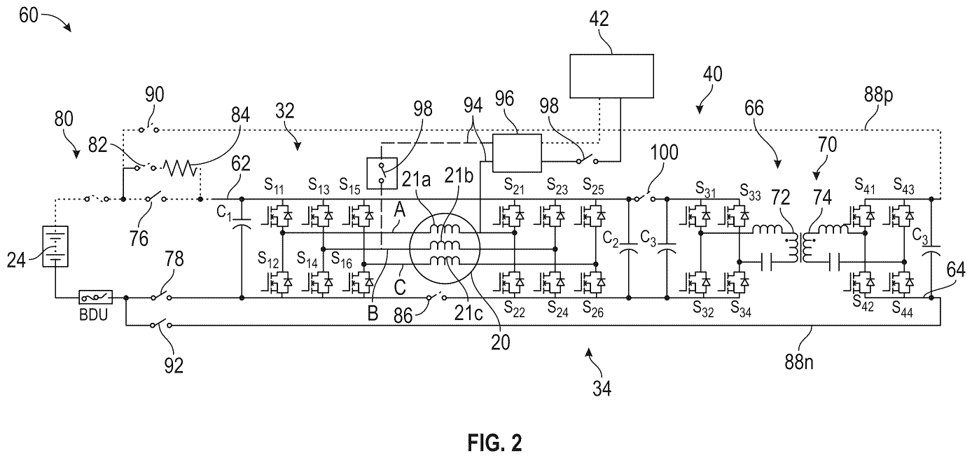

FIG. 2 depicts an embodiment of an electric system 60 of the vehicle 10, which includes a motor-inverter system having dual inverters, and the power module 40. Although the electrical system 60 is described as part of the vehicle 10, the electrical system 60 may be part of any suitable vehicle or other system.

The motor-inverter system includes the motor 20 and the inverters 32 and 34. The inverters 32 and 34 are connected in parallel with each other to a propulsion bus 62. The propulsion bus 62 connects the motor 20 in parallel to phase legs of the inverters 32 and 34.

Each inverter 32 and 34 includes a switching assembly having at least two inverter switches connected to each phase of the three-phase electric motor 20. In this example, the motor 20 is a three-phase motor having phases A, B and C, which includes a first winding 21a (phase A winding), a second winding 21b (phase B winding) and a third phase winding 21c (phase C winding)

For example, the inverter 32 includes a first phase leg having a pair of switches S₁₁ and S₁₂, a second phase leg having a pair of switches S₁₃ and S₁₄, and a third phase leg having a pair of switches S₁₅ and S₁₆. The inverter 34 includes a first phase leg having a pair of switches S₂₁ and S₂₂, a second phase leg having a pair of switches S₂₃ and S₂₄, and a third phase leg having a pair of switches S₂₅ and S₂₆.

In an embodiment, each inverter switch is a semiconductor switch. As non-limiting examples, inverter switches may include metal-oxide-semiconductor (MOS)-controlled Thyristors (MCTs), gallium-nitride (GaN) field-effect transistors (FETs), metal-oxide-semiconductor field-effect transistors (MOSFETs), silicon carbide junction field-effect transistors (SiC JFETs), insulated-gate bipolar transistors (IGBTs) or any other suitable low loss device of suitable voltage and current ratings. The inverters 32 and 34 can each have a capacitor (capacitors C₁ and C₂), or share one single capacitor (e.g., capacitor C₁, with the capacitor C₂ being excluded).

Each phase leg includes an upper switch and a lower switch. An “upper” switch is a switch located between a connection to a winding and a positive side of the propulsion bus 62, and a “lower” switch is a switch located between the connection and a negative side of the propulsion bus 62.

The switches S₁₁ and S₁₂ of the inverter 32 and the switches S₂₁ and S₂₂ of the inverter 34 form phase A legs, and are connected to an end of the first winding 21a (phase A winding). The switches S₁₃ and S₁₄ of the inverter 32 and the switches S₂₃ and S₂₄ of the inverter 34 form phase B legs, which are each connected to an end of the second winding 21b (phase B winding). The switches S₁₅ and S₁₆ of the inverter 32 and the switches S₂₅ and S₂₆ of the inverter 34 form phase C legs, which are each connected to an end of the third winding 21c (phase C winding).

For propulsion, the motor 20 may be operated in an “open winding” mode, in which each phase of the motor 20 is driven according to PWM by a full bridge inverter stage (i.e., two pairs of switches).

The electrical system 60 also includes the power module 40 and the charge port 42. The power module 40 includes an AC-DC conversion stage that uses one or more of the motor windings and associated phase legs for converting AC power to DC power when charging the battery pack 24, and for converting DC power to AC when supplying power to a load from the battery pack 24. The power module 40 also utilizes the motor-inverter system for power factor correction and bi-directional AC-DC conversion as described herein.

The power module 40 includes a charging bus 64 connected to the propulsion bus 62, and a DC-DC converter 66 connected to the charging bus 64 (the DC-DC converter 66 is connectable in parallel with the inverters 32 and 34). The DC-DC converter 66, in an embodiment, is a full bridge isolated DC-DC converter that includes two pairs of switches S₃₁, S₃₂, S₃₃ and S₃₄ connected to a primary winding 72 of a transformer 70, and two pairs of switches S₄₁, S₄₂, S₄₃ and S₄₄ connected to a secondary winding 74 of the transformer 70. The DC-DC converter 66 may also include capacitors C₃ connected in parallel with the switches.

Main switches 76 and 78 are provided for selective connection of the battery pack 24 to the propulsion bus 62. A precharge circuit 80 may be included for precharging the power module 40 and components of the inverters 32 and 34 by providing for a controlled voltage increase. The precharge circuit 80 includes, for example, the main switch 76, a pre-charge relay 82 and a resistor 84 in parallel with the relay 82.

The power module 40 includes or is connected to positive and negative conductors 88p and 88n, which connect the charging bus 64 to the propulsion bus 62. Switches 90 and 92 may be closed (or on) to put the electrical system 60 into a charging mode.

The electrical system 60 includes a charge port circuit used to enable charging and discharging using the motor-inverter system. The charge port circuit includes, for example, charge port conductors 94 that connect the charge port 42 to phase legs of the inverter 32. An input filter 96 may be included.

A set of charge port switches 98 provides for selective connection of the charge port 42 to the motor-inverter system via the conductors 94. There may be a single charge port switch 98, or switches 98 for positive and negative sides of the conductors 94. An additional switch 100 may be provided for selectively connecting the DC-DC converter 66 to the propulsion bus 62.

In use, a processing device, such as the vehicle controller 36, operates the electrical system 60 according to a propulsion mode or a charging mode. In the propulsion mode, the battery pack 24 supplies power to the motor 20, and the motor 20 is driven by modulating switches in the inverter 32 and/or the inverter 34.

In the charging mode, the DC-DC converter 66 is connected to the motor-inverter system and the charge port 42. The battery system 22 is charged from a power source such as a power grid or other AC source, or is charged from a DC power source, such as a charging station (e.g., a DC fast charging (DCFC) charging station). The charging mode may include discharging from the battery system 22 to provide power to an external load (e.g., power grid or another vehicle).

To put the electrical system 60 into the propulsion mode, the main switches 76 and 78, and the switch 86, are closed (or on). The switches 90 and 92, the switch 100 and the switches 98, are open (or off). Prior to closing the main switch 76, the precharge switch 82 may be closed to prevent arcing and then opened after the main switch 76 is closed.

To put the electrical system 60 into the charging mode, the main switches 76 and 78 and the precharge switch 82 are open. The switches 90, 92, and the switch 100 are closed. The charge port switches 98 are also closed.

During a charging or discharging operation, power is flowed between the battery pack 24 and the charge port 42. The switches S₂₁ and S₂₂ may be modulated to perform PFC, and at least one of the motor windings is used for PFC by correcting the power factor using the inductance of a winding or windings. For example, during discharging, the switches S₂₃ and S₂₄ are modulated (e.g., according to a PWM or other modulation scheme), and PFC is performed using the motor winding 21b.

In some instances, the rotor position of the motor 20 is such that a motor winding does not have sufficient inductance. The processing device may be configured so that the winding or windings used for PFC can be changed to mitigate this issue.

For example, PFC can be performed using only the motor winding 21b by opening all of the switches of the inverter 32 (the switch 86 is open). PFC can instead by performed using only the motor winding 21c by closing switches S₁₄ and S₁₆ and opening the remaining switches of the inverter 32.

Multiple motor windings may be used for PFC. For example, the processing device can close both switches S₁₄ and S₁₆ to perform interleaved PFC.

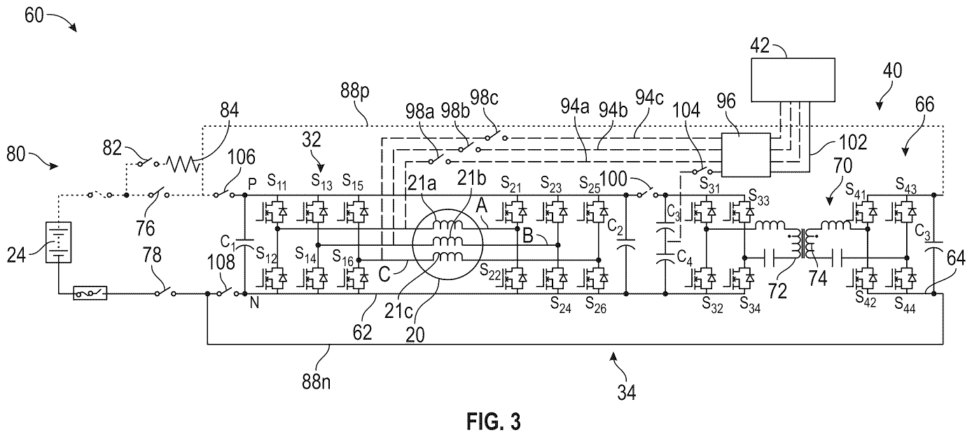

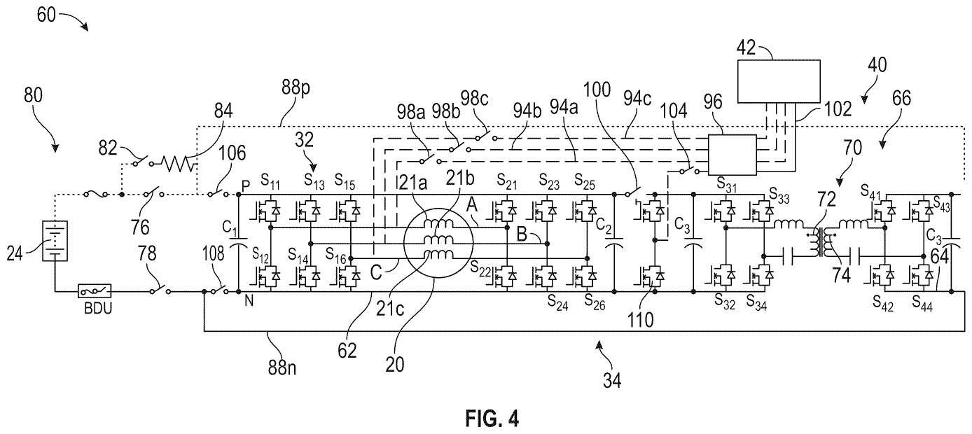

FIGS. 3 and 4 depict embodiments of the electrical system 60 as configured for three-phase charging and discharging. The charge port circuit selectively connects each phase of the motor-inverter system to the charge port 42.

In these embodiments, the charge port circuit includes a conductor 94a that connects the phase A legs to the charge port 42, a conductor 94b that connects the phase B legs to the charge port 42, and a conductor 94c that connects the phase C legs to the charge port 42. Charge port switches 98a, 98b and 98c are disposed at the conductors 94a, 94b and 94c, respectively.

An additional conductor 102 connects the charge port 42 to a neutral point of the electrical system 60 or components thereof. A switch 104 may be provided at the conductor 102.

Also in these embodiments, the charging conductors 88n and 88p connect to the propulsion bus 62 at connection points between the main switches and the inverter 32 (as opposed to the embodiment of FIG. 2, in which the conductors terminate between the battery pack 24 and the main switches 76 and 78). To transition to a charging mode, switches 106 and 108 are provided between the connection points and the inverter 32.

For example, as shown in FIG. 3, two capacitors C₃ and C₄ are connected as a split capacitor to the charging bus 64 in parallel with the DC-DC converter 66. In this example, the neutral point is a midpoint between the capacitors C₃ and C₄.

In another example, shown in FIG. 4, the power module 40 includes a pair of switches 110 that are connected to the charging bus 64. The neutral point in this example is a midpoint between the switches 110.

In use, the processing device can operate the electrical system 60 according to the propulsion mode by closing the main switches 76 and 78, and the switches 106 and 108 are closed. The switches 98a, 98b, 98c and 104 are open.

To put the electrical system 60 into a charging mode, the main switches 76 and 78 are closed, and the switches 106 and 108 are open. The switches 98a, 98b, 98c and 104 are closed. All of the switches of the inverter 32 are open.

During a charging or discharging operation, one or more of the motor windings are used for PFC as discussed above.

The power module 40 may be configurable to allow for bi-directional or uni-directional charging.

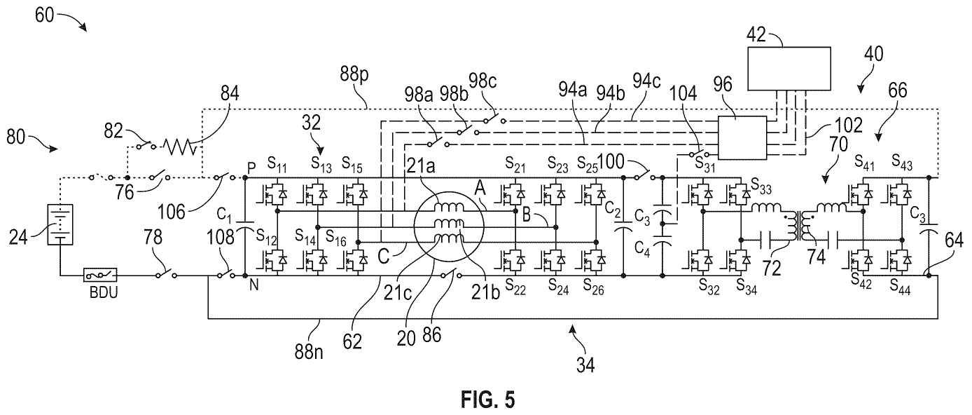

FIG. 5 shows an embodiment of the power module 40 and the electrical system 60, which can be controlled to transition between single-phase and three-phase charging and discharging. In this embodiment, a switch 86 is provided to enable this transition. The switch 86 is provided at the propulsion bus 62 between the inverter 32 and the inverter 34. The switch 86 is operable to configure the power module 40 for single-phase charging or discharging (by opening the switch 86) or three-phase charging and discharging (with the switch 86 being either open or closed).

For example, to enable single-phase charging using a phase B leg, the switches 98b and 104 are closed. The switch 86 and the switches 98a and 98c are open. Single-phase charging can be enabled for other phase legs by instead closing another of the charge port switches (switch 98a or 98c), and opening the remaining charge port switches.

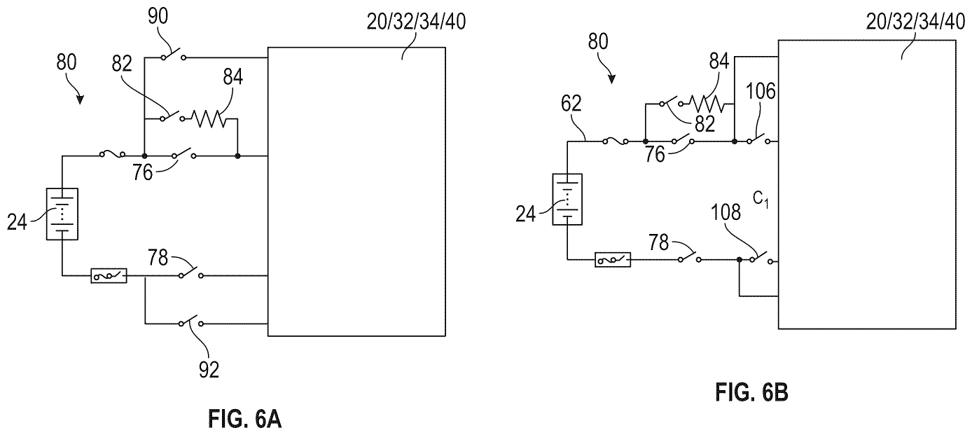

FIGS. 6A and 6B show examples of how the power module 40 can interface with the battery pack 24. In the example of FIG. 6A, the power module 40 is connectable using switches at the charging conductors (e.g., the switches 90 and 92). In the example of FIG. 6B, the power module 40 is connectable using switches at the propulsion bus 62 (e.g., the switches 106 and 108). Each of the embodiments described herein can utilize either of these interface configurations, depending on factors such as battery packaging and current requirements.

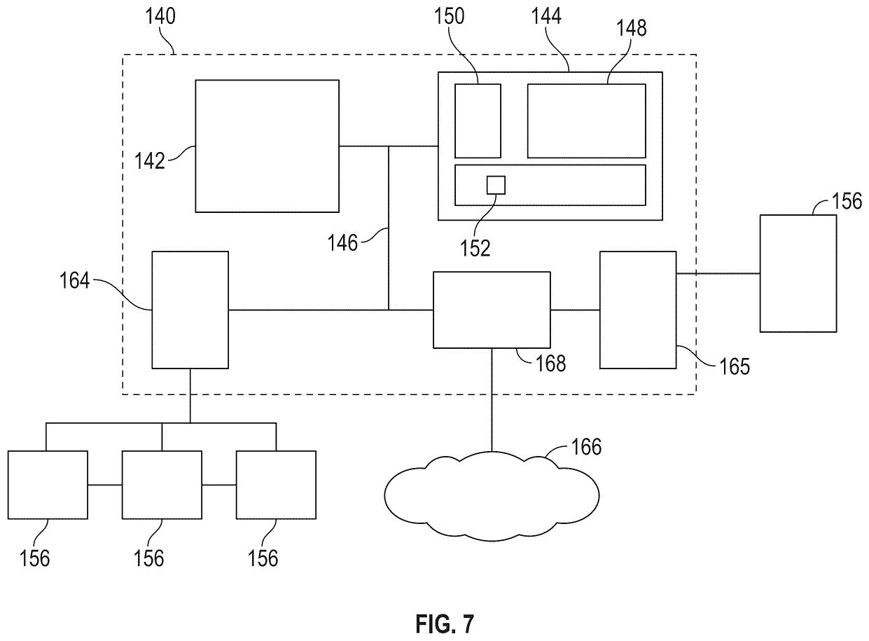

FIG. 7 illustrates aspects of an embodiment of a computer system 140 that can perform various aspects of embodiments described herein. The computer system 140 includes at least one processing device 142, which generally includes one or more processors for performing aspects of methods described herein.

Components of the computer system 140 include the processing device 142 (such as one or more processors or processing units), a memory 144, and a bus 146 that couples various system components including the system memory 144 to the processing device 142. The system memory 144 may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to performing charging and discharging operations described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for controlling charging and discharging, comprising:
an electrical system including a power module selectively connected to a battery assembly, the power module including a direct current (DC)-DC conversion device, the battery assembly configured to provide power to a dual inverter motor system, the dual inverter motor system including a first inverter and a second inverter connected to a multi-phase electric motor by a propulsion bus, the first inverter including a first plurality of phase legs and the second inverter including a second plurality of phase legs;
a charge port circuit including a charge port conductor configured to selectively connect a set of windings of the multi-phase electric motor to a charge port;
a switching assembly including a charge port switch at the charge port conductor; and
a controller configured to transition the electrical system between a propulsion mode and a charging mode by controlling the charge port switch, wherein the controller is configured to control the electrical system in the charging mode to charge the battery assembly or supply power to a load through the dual inverter motor system.

2. The system of claim 1, wherein the charge port circuit is configured to cause power flow through at least one winding of the multi-phase electric motor for power factor correction and bi-directional alternating current (AC)-DC conversion.

3. The system of claim 2, wherein the charge port circuit includes a first conductor connecting the charge port to one of the set of windings through a phase leg of one of the first inverter or the second inverter, and a second conductor connecting the charge port to another of the set of windings through a phase leg of another of the first inverter or the second inverter.

4. The system of claim 2, wherein the controller is configured to select the at least one winding for the power factor correction and the bi-directional AC-DC conversion by controlling at least one switch in the first inverter.

5. The system of claim 4, wherein the controller is configured to select the at least one winding based on a rotor position of the multi-phase electric motor.

6. The system of claim 4, wherein the controller is configured to select multiple windings and perform interleaved power factor correction by controlling at least one switch that is connected to a selected winding.

7. The system of claim 2, wherein the charge port circuit includes a plurality of conductors connecting the charge port to each winding of the set of windings and to each phase leg of the first inverter or the second inverter, and the charge port circuit includes an additional conductor connecting the charge port to a neutral point of the electrical system or a midpoint between a pair of switches connected in parallel with the first inverter and the second inverter.

8. The system of claim 7, wherein each of the plurality of conductors includes a respective charge port switch, and the controller is configured to control one or more of the respective charge port switches to select multi-phase or single-phase charging or discharging.

9. A method comprising:
monitoring an electrical system including a power module selectively connected to a battery assembly, the power module including a direct current (DC)-DC conversion device, the battery assembly configured to provide power to a dual inverter motor system, the dual inverter motor system including a first inverter and a second inverter connected to a multi-phase electric motor by a propulsion bus, the first inverter including a first plurality of phase legs and the second inverter including a second plurality of phase legs;
causing the electrical system to transition between a propulsion mode and a charging mode by controlling a charge port circuit, the charge port circuit including a charge port conductor that selectively connects a set of windings of the multi-phase electric motor to a charge port, wherein the controlling includes opening or closing a charge port switch at the charge port conductor; and
based on the electrical system being in the charging mode, controlling the electrical system in the charging mode to charge the battery assembly or supply power to a load through the dual inverter motor system.

10. The method of claim 9, wherein the charge port circuit is configured to cause power flow through at least one winding of the multi-phase electric motor for power factor correction and bi-directional alternating current (AC)-DC conversion.

11. The method of claim 10, wherein the charge port circuit includes a first conductor connecting the charge port to one of the set of windings through a phase leg of one of the first inverter or the second inverter, and a second conductor connecting the charge port to another of the set of windings through a phase leg of another of the first inverter or the second inverter.

12. The method of claim 10, wherein controlling the electrical system includes selecting the at least one winding for the power factor correction and the bi-directional AC-DC conversion by controlling at least one switch in the first inverter.

13. The method of claim 12, wherein the at least one winding is selected based on a rotor position of the multi-phase electric motor.

14. The method of claim 12, wherein controlling the electrical system includes selecting multiple windings and performing interleaved power factor correction by controlling at least one switch that is connected to a selected winding.

15. The method of claim 10, wherein the charge port circuit includes a plurality of conductors connecting the charge port to each winding of the set of windings and to each phase leg of the first inverter or the second inverter, and the charge port circuit includes an additional conductor connecting the charge port to a neutral point of the electrical system or a midpoint between a pair of switches connected in parallel with the first inverter and the second inverter.

16. The method of claim 15, wherein each of the plurality of conductors includes a respective charge port switch, and the method further comprises controlling one or more of the respective charge port switches to select multi-phase or single-phase charging or discharging.

17. A vehicle system comprising:
a dual inverter motor system including a first inverter and a second inverter connected to a multi-phase electric motor, the first inverter including a first plurality of phase legs and the second inverter including a second plurality of phase legs;
a power module selectively connected to a battery assembly, the power module including a direct current (DC)-DC conversion device, the battery assembly configured to provide power to the dual inverter motor system;
a charge port circuit including a charge port conductor configured to selectively connect a set of windings of the multi-phase electric motor to a charge port;
a switching assembly including a charge port switch at the charge port conductor; and
a controller configured to transition the vehicle system between a propulsion mode and a charging mode by controlling the charge port switch, wherein the controller is configured to control the vehicle system in the charging mode to charge the battery assembly or supply power to a load through the dual inverter motor system.

18. The vehicle system of claim 17, wherein the charge port circuit is configured to cause power flow through at least one winding of the multi-phase electric motor for power factor correction and bi-directional alternating current (AC)-DC conversion.

19. The vehicle system of claim 18, wherein the charge port circuit includes a first conductor connecting the charge port to one of the set of windings through a phase leg of one of the first inverter or the second inverter, and a second conductor connecting the charge port to another of the set of windings through a phase leg of another of the first inverter or the second inverter.

20. The vehicle system of claim 18, wherein the controller is configured to select the at least one winding for the power factor correction and the bi-directional AC-DC conversion by controlling at least one switch in the first inverter.
